(19) United States
(12) Patent Application Publication
(10) Pub. No.: US 2014/0279863 A1
(43) Pub. Date: Sep. 18, 2014

(54) Network context-based content positioning for OTT delivery

(71) Applicant: HCL Technologies Ltd., Chennai (IN)

(72) Inventors: Shashidhar Krishnamurthy, Noida (IN); Mukta Agarwal, Noida (IN); Saurabh Chattopadhyay, Noida (IN)

(73) Assignee: HCL Technologies Ltd

(21) Appl. No.: 13/945,839

(22) Filed: Jul. 18, 2013

(30) Foreign Application Priority Data
Mar. 14, 2013 (IN) 1078/CHE/2013

(51) Int. Cl. G06F 17/30

(52) U.S. Cl. CPC G06F 17/30321
USPC 707/609; 707/743

(57) ABSTRACT

The embodiments provides a method for network-context based content positioning. The method includes receiving a plurality of parameters associated with content, and computing a content positioning relevance index for one or more node using the plurality of parameters. Further, the method includes positioning the content in the network based on the content positioning relevance index.

### PRIORITY DETAILS

The present application is based on, and claims priority from, Indian Application Number 1078/CHE/2012, filed on 14 March, 2013, the disclosure of which is hereby incorporated by reference herein.

### TECHNICAL FIELD

The embodiments herein relate to network context-based systems, and more particularly, to a mechanism for network context-based content positioning for Over-The-Top (OTT) delivery.

### BACKGROUND

The increasing accessibility to the Internet has fueled a corresponding increase in the accessibility of multimedia content. The ever-increasing amount of traffic over the Internet creates surmounting demands on the network operators to consistently provide contents to users. A number of factors, such as for example, but not limited to, bandwidth, usage, resources, availability, cost, performance, time, reliability, optimization, and the like, can continue attributing for explosion of accessing the content over the network.

Different systems and methods are proposed to provide sustainable responses for the surmounting demands. Implementation of content delivery network can reduce the overall cost spent on the operators. Content providers can subscribe for the services provided by content delivery network operators and position the content near to particular locations. This can enable better ability to reach the selected set of content for local users. Conventional systems and methods include speculating popularity of the content and caching it based on the demand. Such speculative demand models require consideration of Service Level Agreements (SLA) and impact of speculative popularity distribution of the content in different service levels. For example, if the network operator includes an SLA with content providers for serving certain set of content in a defined service level then the speculative demand model also considers the same. The derivation of the speculating demand can be performed based on the usage popularity, SLAs, storage, and transport expenses. Further, the conventional system includes allowing the network operators to establish a collaborative environment within the operator's network where multiple systems interwork and serves content to each other based on the demand.

Though the conventional systems and methods are effective to a degree in providing sustainable responses for the surmounting demands over the network but may not consider operational and commercial context of the network while deciding the content positioning. Further, the systems and method may not offer a blended mechanism of utilizing localized and centralized perception of network context.

### SUMMARY OF THE EMBODIMENTS

Accordingly the embodiments provides a method for network-context based content positioning. The method includes receiving a plurality of parameters associated with the content, and computing a content positioning relevance index for one or more node using the plurality of parameters. Further, the method includes positioning and/repositioning the content in the network based on the content positioning relevance index.

In an embodiment, the parameters associated with the content includes for example, but not limited to, usage, transport cost, resources, storage space, storage expense, service level agreements (SLAs), and the like. The nodes include for example, but not limited to, local node and central node.

Further, the method includes prioritizing the parameter associated with the content, combining the prioritized parameter to compute the content positioning relevance index, and storing the content positioning relevance index in a metadata. In an embodiment, the parameters are prioritized locally and/or centrally. Further, the method includes ranking the content based on the content positioning relevance index, storing the ranking of the content in the metadata, and caching the content in the network based on the ranking. In an embodiment, the content is ranked locally and/or centrally.

Further, the method includes monitoring the parameters associated with the content in the network, and frequently updating the metadata in accordance to the monitoring result. Further, the method includes receiving a request to access the content in the network, determining whether the content is available locally, and delivering the content in response to determining that the content is available locally. Further, the method includes collaborating the nodes in response to determining that the content is available centrally, scanning the nodes to identify the content using the content positioning relevance index, and delivering the content from the collaborated nodes.

Accordingly the embodiments provides a system for network-context based content positioning. The system is configured to receive a plurality of parameters associated with the content, and compute a content positioning relevance index for one or more node using the plurality of parameters. Further, the system is configured to position and/reposition the content in the network based on the content positioning relevance index.

Further, the system is configured to prioritize the parameter associated with the content, combine the prioritized parameter to compute the content positioning relevance index, and store the content positioning relevance index in a metadata. In an embodiment, the parameters are prioritized locally and/or centrally. Further, the system is configured to rank the content based on the content positioning relevance index, store the ranking of the content in the metadata, and cache the content in the network based on the ranking. In an embodiment, the content is ranked locally and/or centrally.

Further, the system is configured to monitor the parameters associated with the content in the network, and frequently update the metadata in accordance to the monitoring result. Further, the system is configured to receive a request to access the content in the network, determine whether the content is available locally, and deliver the content in response to determining that the content is available locally. Further, the system is configured to collaborate the nodes in response to determining that the content is available centrally, scan the nodes to identify the content using the content positioning relevance index, and deliver the content from the collaborated nodes.

Accordingly the embodiments provides a computer program product for network-context based content positioning. The computer program product includes an integrated circuit. The integrated circuit includes a processor, a memory including a computer program code within the circuit. Further, the memory and the computer program code with the processor cause the product to receive a plurality of parameters associated with the content, and compute a content positioning relevance index for one or more node using the plurality of parameters. Further, the product includes position and/reposition the content in the network based on the content positioning relevance index.

These and other aspects of the embodiments herein will be better understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 is a diagram illustrates generally, among other things, a high level architecture of system, according to the embodiments disclosed herein;

FIG. 2 illustrates generally, an exemplary structure of metadata, according to embodiments described herein;

FIG. 3 is a sequence diagram illustrates generally, operations performed among local and central nodes as described in the FIGS. 1 and 2, according to the embodiments disclosed herein;

FIG. 4 is a state transition diagram illustrates generally, exemplary state transitions for tracked content, according to embodiments described herein;

FIG. 5 is a state transition diagram illustrates generally, exemplary state transitions for local ranked list, according to embodiments described herein;

FIG. 6 is a flowchart illustrates generally, a method for serving content in a collaborative environment, according to the embodiments disclosed herein;

FIG. 7 is a flowchart illustrates generally, a method for network-context based content positioning, according to the embodiments disclosed herein; and

FIG. 8 illustrates a computing environment implementing the method and system as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for network-context based content positioning. Unlink conventional systems; the present embodiments proposes a network-context based content positioning system that collaborates with all intermediate content serving nodes (both local and central) to effectively position content in the network. The present embodiments provides a mechanism for collaborating local and central perceptions of network context and effectively position the content by considering operational and commercial context of the network. The method includes receiving one or more parameters associated with the content in the network. The parameters described herein can include for example, usage, transport cost, resources, storage space, service level agreements (SLAs), and the like. The content can be provided to users from a plurality of nodes including both local and central nodes passing through various level of content serving paths. A content positioning relevance index can be computed by prioritizing the one or more parameters associated with the content at each node in the network. Further, the method includes positioning the content in the network based on the content positioning relevance index. The contents can be delivered to the users by frequently collaborating and updating the nodes (both local and central) based on the content positioning relevance index.

The proposed system and method is simple, robust, dynamic, inexpensive, and reliable for positioning content in a network for Over-The-Top delivery. Unlike conventional systems and methods, the present embodiments considers operational and commercial context of the network to derive appropriate content position in the network. The system and method can be used to improve effectiveness of the content delivery by monitoring and managing performances of the content through collaborative links. The overall delivery capability of the system can be enhanced by collaborating both local and central nodes to position the content in the network. The local ingestion point for popular content can enable offering better quality of experience (QoE) for the local users. The central intelligence for content positioning can keep track of demographic popularity to improve the overall QoE. The system and method can be used to define priority/weight for the various parameters associated with the content at each node (both local and central), such as to orient the content positioning/repositioning in the complete network and maximize the overall benefits of the system. The system considers the SLAs associated with content serving nodes while positioning the content in the network. The relative importance of the SLA gets derived as per administrative configuration at the node to improve the service level compliance as governed by network operators. Further, the present embodiments provides a feedback mechanism for performances of collaborative content serving environment, which can be used to offer input to plan for improving next level of the QoE. Furthermore, the proposed system and method can be implemented on the existing infrastructure and may not require extensive set-up or instrumentation.

FIG. 1 is a diagram illustrates generally, among other things, a high level architecture of system 100, according to the embodiments disclosed herein. The system 100 can be configured include one or more nodes 102 communicating among each other over a communication network. In an embodiment, the one or more nodes 102 described herein can include for example, but not limited to, content providers/sources, user/customer devices, Point-of-Presence, local Point-of-Presence, central Point-of-Presence, local nodes, central nodes, central aggregator, intermediate content providers, third-party nodes, proxies, routers, aggregators, gateway devices, and the like. In an embodiment, the communication network described herein can include for example, but not limited to, wireless communication network, wire line communication network, cellular network, global system for mobile communication, local area network, wide area network, public network such as the Internet, private network, personal area network, combination thereof, and the like.

The system 100 can be configured to include content providers context 104, network operator's context 106, and network user's context 108 including the one or the more nodes 102 communicating over the communication network. In an embodiment, the content provider's context 104 described herein allows the one or more nodes (such as the content providers or sources) to host the content over the communication network. The content sources/providers can publish the content and ingest the same into the network operator's context 106. The network operator's context 106 can include various intermediate serving nodes in different points of presence. The network operator's context 106 can include a central point in the deployment architecture that can act as a central aggregation point. The central point can be configured to poll the local intelligence data from each of the points of presence and push centrally processed decisions to be implemented in local positions. Further, a sequence of these serving nodes forms the content delivery path, and the content can be delivered to the network user's context 108. Further, various operations performed by the system 100 are described in conjunction with FIGS. 2 through 7.

Thought, the content sources shown in the FIG. 1 are relative sources from where the network operators receive the content but, it is to be understood that another exemplary embodiment is not limited thereto. In real time, the content sources may be hosted by the content provider, or content delivery network operator, or even another upstream network operator owning the content distribution mechanism to this downstream network operator. The embodiments described here remains agnostic to the actual commercial identity and gets logically represented as an immediate upstream entity for the network operator (from where the content sourcing and ingestion can be carried out).

In an embodiment, the high level architecture of the system 100 can establish the one or nodes 102 in different levels of deployment, starting from the consumer/user facing point of presences in access network level to aggregation levels and, further till core network and interconnections levels. As a common measurement for the delivery optimization, many of the nodes described herein can be equipped with caching software's based on popularity, usage and other utility factors of the content. Further, the content sourced from Over-The-Top (OTT) services can get cached into the nodes (such as servers). These servers can further act as intermediate content ingestion points for the users, who requested the delivery of the cached content and the delivery request(s) can get routed via these intermediating nodes. In an embodiment, these intermediate serving nodes can be considered as the deployment entities where the present embodiments can be hosted. Further, in an embodiment, such intermediate serving nodes can include servers with in-built multiple networking interfaces including advanced network communication capabilities configured through multiple network cards. The embodiments thus can be practiced on any such nodes, which can include multi-core processor based systems, network processor based systems, Advanced Telecommunications Computing Architecture (ATCA) based systems, blade servers, and other computing environment associated with the multiple network interfaces.

FIG. 2 illustrates generally, an exemplary structure of metadata 200, according to embodiments described herein. In an embodiment, the content can be provided to the users from the one or more of nodes 102, including both local and central nodes, passing through various level of content serving paths. The content can be associated with a plurality of parameters. The parameters described herein can include for example, but not limited to, usage, transport expanse, storage expense, resources, storage space, service level agreements (SLAs), and the like. For an entire serving network, each node 102 can include varying sensitivity attached for the storage and transport expenses. In the operational context during content serving, the storage and transport expenses play a major role for serving and managing contents over the communication network. In an embodiment, administrators can have complete visibility on these sensitivities and can be able to provision the relative preferences/weights of these parameters at each node 102. The popularity of the content and distribution of the popularity in different demography are the factors derived from the context of content usage by the users. The commercial relationships established between the content providers and the network operators, and also between the users and network operators, can introduce the SLAs in the context of content serving. These SLAs are important contextual attributes which contributes to identify relevant positioning of the content in the communication network.

Further, the system 100 can be configured to compute a content positioning relevance index (CPR-I) to provide effective contents over the communication network. The CPR-I can be computed by prioritizing the one or more parameters associated with the content at each node 102 in the network. The priority/weight to the various parameters associated with the content can be assigned at each node 102 (both local and central), such as to orient the content positioning/repositioning in the complete network and maximize the overall benefits of the system 100.

In an embodiment, the CPR-I can be computed by prioritizing the one or more parameters associated with the content at each node 102. For example, consider the configured weight/priority of the parameters in the local node as w1%+w2%+w3%+w4%=100. Where, the w1% represents the weight/priority for the transport expense parameter, the w2% represents the weight/priority for the storage expense parameter, the w3% represents the weight/priority for the SLAs parameter, and the w4% represents the weight/priority for the popularity parameter, respectively. The SLAs as recognized in the local nodes can be represented as SLA1, SLA2, and SLA3, respectively. Where, the SLA1 represents highest G1 guaranteed level of services, the SLA2 represents next G2 guaranteed level of services, and the SLA3, represents next G3 level of services. For exemplary presentation of mathematical model, only three SLA levels are considered for use during the content delivery but, it is to be understood that another exemplary embodiments are not limited thereto. In these service levels, it is assumed that a distinguishable attribute exists for all service levels that homogeneously define the guaranteed level of serviceability.

Further, consider an exemplary content (C) with content size (Cs) and whose current popularity can be represented as Cₚ=Cₚ^{SLA1}+Cₚ^{SLA2}+Cₚ^{SLA3}. Where, the Cₚ^{SLA1} represents occurrences of the serving content under the SLA1, the Cₚ^{SLA2} represents occurrences of the serving content under the SLA2, and the Cₚ^{SLA3} represents occurrences of serving content under the SLA3, respectively.

In an embodiment, the CPR-I can be computed as:

$$CPR \text{-} I = ( Cs \times {C}_{p} - 1 ) \times w 1 \% + ( {C}_{p} \times w 4 \% ) + ( {C}_{p}^{SLA 1} \times ( ( w 3 \% \times ( G 1 / ( G 1 + G 2 + G 3 ) ) \times 100 \% ) \times 100 \% ) ) + ( {C}_{p}^{SLA 2} \times ( ( w 3 \% \times ( G 2 / ( G 1 + G 2 + G 3 ) ) \times 100 \% ) \times 100 \% ) ) + ( {C}_{p}^{SLA 3} \times ( ( w 3 \% \times ( G 3 / ( G 1 + G 2 + G 3 ) ) \times 100 \% ) \times 100 \% ) ) - ( Cs \times w 2 \% )$$

In an embodiment, the generic formula for computing the CPR-I using ‘n’ number of service levels can be computed as:

$$CPR \text{-} I = ( Cs \times ( {C}_{p} - 1 ) \times w 1 \% ) + ( {C}_{p} \times w 4 \% ) + ( {C}_{p}^{SLA 1} \times ( ( w 3 \% \times ( G 1 / \sum Gn ) \times 100 \% ) \times 100 \% ) ) + ( {C}_{p}^{SLA 2} \times ( ( w 3 \% \times ( G 2 / \sum Gn ) \times 100 \% ) \times 100 \% ) ) + ( {C}_{p}^{SLA 3} \times ( ( w 3 \% \times ( G 3 / \sum Gn ) \times 100 \% ) \times 100 \% ) ) + ( {C}_{p}^{SLA n} \times ( ( w 3 \% \times ( G n / \sum Gn ) \times 100 \% ) \times 100 \% ) ) - ( Cs \times w 2 \% )$$

In an embodiment, the weight driven combination of the parameters associated with the contents can used quantify a particular content as worthy candidate for caching/storing at the particular position of the network. The linearity and configurability weight parameters (w1, w2, w3, w4 as described above) of the parameters can be combined, such as to ensure the CPR-I is not overly influenced by any particular parameter beyond the administrative intentions. While the transport expense parameters in the network operator's context 106 can include multiple sub-heads. The system 100 can be configured to establish relational preferences/weight of the transport expenses that can get driven as per the content size as being transported. Additional expenses related to the higher bandwidth transport or higher level of services can be considered in the head of the SLAs and accordingly relational priority/weight can be defined.

In an embodiment, the system 100 can allow the administrators to define the relative priority/weight to the parameters associated with the content. The administrators can be guided by the following notions while configuring the relative priority/weight to the parameters. In an embodiment, if the transport expense per MB for a particular network region is R1 and the storage expense per MB is R2 then the configurable weight for the transport expense (w1) and storage expense (w2) can be represented in ratio of w1:w2=R1:R2. In an embodiment, if a weight to be given for lower sized and popular content, and if the popularity is to be preferred ‘n’ times more over the content size then the configurable weight for the transport expense (w1) and the popularity (w4) can be represented in ratio of w1:w4=1:n.

As shown in the FIG. 2, the computed CPR-I for the content can be stored in the local node, and the metadata structure 100 can be used to hold the related information. The FIG. 2 shows exemplary metadata structure 200 and information computed by the system 100. The tracked content can be identified through a content identifier. The content can be locally ranked by the local nodes, such as to identify whether the content qualifies to cache/store in particular position of the network. The locally computed CPR-I and the corresponding content identifier along with the local raking of the content can be maintained in the metadata 200. The local ranking can be done based on the CPR-I value of all the tracked content in the particular point-of-presence. Similarly, in an embodiment, the content can also be tracked by the central nodes (also referred as central aggregation points). The central nodes follows similar computation process for computing the central CPR-I using the parameters associated with the content. As shown in the FIG. 2, each point of presence establishes a partition in its available storage, dividing the same into two parts, namely central zone of influence 202 and local influence 204, respectively. The local influence 204 can be dedicated to store content as per the CPR-I monitored, measured, and weighed locally by the local nodes. Similarly, the central zone of influence 202 can be dedicated to store content as per the CPR-I monitored, measured, and weighed centrally by the central nodes. The centrally computed CPR-I can also get updated in the local metadata structure 200. The state transition for the content items can be governed by the central point. Further, the state transitions for the content are described in conjunction with the FIGS. 4 and 5.

In an embodiment, the local computation of the CPR-I and ranking can be carried on and reported to the central nodes. The content that are influenced and tracked locally marks the ‘Zone of Influence’ field accordingly in the metadata structure 200, and central point continues monitoring the content items passively. Further, the operations performed between the local and central nodes to manage the content are described in conjunction with the FIG. 3.

In an embodiment, the position pointer field can be used to specify the location of the content as available. The position pointer field can be used to identify the content that is remotely placed in the administrator provisioned collaborative nodes. For example, as show in the FIG. 2, the metadata structure 200 represent the content (C₂) are placed remotely. The nodes 102 can be configured to keep track of the content availability in different nodes and identify the provisioned collaborative nodes for each point of presence, and accordingly update the ‘Position Pointer’ field of the metadata structure 200. Further, the system 100 can be configured to position the content in the network based on the CPR-I. The various operations 300 performed by the system 100 to collaborate the local and central links for effectively positioning the content over the communication network are described with respect to the FIG. 3.

FIG. 3 is a sequence diagram illustrates generally, operations 300 performed among local and central nodes as described in the FIGS. 1 and 2, according to the embodiments disclosed herein. In an embodiment, the system 100 can be used to improve the effectiveness of the content delivery by monitoring and managing performances of the content through collaborative links. The overall delivery capability of the system 100 can be enhanced by collaborating both local and central nodes to position the content in the network. The local ingestion point for the popular content can enable offering better quality of experience (QoE) for the local users. The central intelligence for content positioning can keep track of demographic popularity to improve the overall QoE.

In an embodiment, at 302, the local node (or point of presence) can be configured to define partitions for the central zone of influence 202 and local influence 204. The content that are influenced and tracked locally can be marked in the metadata structure 200. The local influence 204 can be dedicated to store content as per the CPR-I monitored, measured, and weighed locally by the local nodes. Similarly, the central zone of influence 202 can be dedicated to store content as per the CPR-I monitored, measured, and weighed centrally by the central nodes.

In an embodiment, at 304, the central nodes (or central aggregation point) can be configured to detect all the point(s) of presence capable to collaborate over the network. The central nodes can be configured to passively monitor/track the content and the nodes to collaborate over the communication network. In an embodiment, at 306, the local nodes can be configured to compute, recomputed, and track/monitor the CRP-I for the content served in the communication network. The tracked content can be identified through a content identifier. Each parameters associated with the content can be locally ranked by the local nodes to identify whether the content qualifies to cache/store in particular position of the network. The locally computed CPR-I and the corresponding content identifier along with the local raking of the content can be maintained in the metadata 200.

In an embodiment, at 308, the system 100 allows the local nodes to frequently update the CPR-I and the metadata information. Each local node can be configured to can be configured to track the content over the communication and frequently update the central point with the CPR-I and meta-information of tracked content. In an embodiment, at 310, the central nodes can be configured to define collaborative nodes for each point of presence. The system 100 can be used to improve the effectiveness of the content delivery by monitoring and managing performances of the content through the collaborative links.

In an embodiment, at 312, the central nodes can be configured to analyze the CPR-I for the content at each node present in the communication network. Further, the central nodes can be configured to compute a central CPR-I for the content. The central nodes can be configured to follow the similar computation process (as described in the FIG. 2) for computing the central CPR-I using the parameters associated with the content. The centrally computed CPR-I also get updated in the local metadata structure 200. In an embodiment, at 314, the central nodes can be configured to identify content positioning for the established collaboration. The central node can be configured to command the local node to position the content under the central zone of influence, such as shown at 316. The performances reports of each collaborative link from the local nodes can be used by the central nodes to issue the command on provision/re-provision the collaborative nodes.

In an embodiment, at 318, the local node can be configured to monitor and measure the performance of each collaborative link. Any change in the performance of the collaborative links can effective the performance of the over all system 100. The system 100 allows the local nodes to monitor the performance of the collaborative links and report to the central node for further analysis, such as shown at 320. The local node can be configured to update the CPR-I for the content based on the monitoring results and report the corresponding information to the central nodes.

In an embodiment, at 322, the central nodes can be configured to analyze the locally updated CPR-I for the content and updates the central CRP-I for the content. Further, the central nodes can be configured to identify content positioning for the established collaboration using the updated CPR-I information, such as shown at 324.

In an embodiment, 326, the central nodes can be configured to redefine the collaborative nodes for each point of presence. The system 100 can be used to improve the effectiveness of the content delivery by continuously monitoring and managing performances of the content through the collaborative links. The central node can be configured to command the local node to reposition the content under the central zone of influence, such as shown at 328. The continuous performances reports of each collaborative link from the local nodes can be used by the central nodes to issue the command for effectively positioning/repositioning the content in the network.

FIG. 4 is a state transition diagram illustrates generally, exemplary state transitions 400 for the tracked content, according to embodiments described herein. In an embodiment, at the transition state 402, the parameters associated with the served content in the network can be frequently monitored. Any changes in these parameters can affect the overall performance of the system 100.

In an embodiment, at state transitions 404, the system 100 can be configured to recompute the CPR-I associated with the served content. The change in the values for the monitored parameters associated with the served content can act as a trigger for initiating computation/re-computation of the CPR-I for the particular content. In an embodiment, at state transitions 406, the system 100 can be configured to re-compute the ranking of the CPR-I of the served content. If the CPR-I of particular content changes significantly then the current ranking (may be local or central) may not be valid. The system 100 can be configured to consider force pushed and pre-computed CPR-I (for both local and central) and the improved CPR-I at each node to re-compute the ranking of the served content.

In an embodiment, at state transition 408, the system 100 can be configured to position/reposition the content using the improved/updated CPR-I for the served content. In an example, the positioning of content can be performed under the central zone of influence and the local nodes continues computing/re-computing the CPR-I within the scope. Further, the content remains positioned and tracked at the particular local node and unless commanded by central nodes to reposition the content in the network. Similarly, the central nodes can also position/reposition the content in the local node even if the local nodes computed rank for the content not yet passed the lowest rank among the positioned content.

In an embodiment, at state transition 410, the system 100 can be configured to maintain the CPR-I decay. The highest % change of a particular content's CPR-I during the re-ranking state can be considered as the decay % for all the contents that are not changed during this state. In an embodiment, at state transition 412, the system 100 can be configured to remove the positioned content in the network but, still keeps tracking the CPR-I of the content. The CPR-I decaying and decreased ranking for the content due to the usage of other content can be tracked centrally by the central nodes. The system 100 can be configured to remove the positioned content if the content includes lower order of the CPR-I but, still keeps tracking the CPR-I of the content.

In an embodiment, at state transition 414, the system 100 can be configured to remove the content from the tracking purview in the network. The system 100 can be configured to maintain idle-timeout duration for the content, such as to remove the content which is not accessed for a certain time period. For example, if the content includes lower order of CPR-I and not accessed from a certain time period (idle-timeout duration) then the system 100 can remove the content from the tracking purview. The idle-timeout duration of the content can be manually configured by the administrator or automatically by the system 100, such as to remove the content from the tracking purview in the network. In an embodiment, at state transition 416, the system 100 can be configured to remove the metadata information associated with the content at a particular node. The system 100 removes the metadata including the CPR-I and other tracked attributes for that particular nodes.

FIG. 5 is a state transition diagram illustrates generally, exemplary state transitions 500 for local ranked list, according to embodiments described herein. The positioned content(s) are maintained in a list, and the FIG. 5 shows the state transitions 500 of such ranked list. In an embodiment, at state transition 502, the system 100 can be configured to monitor and compute the ranking of the content using the CPR-I. The ranking can be performed by both the local and central nodes based on the local and central computed CPR-I for the served content over the communication network.

In an embodiment, at state transition 504, the system 100 can be configured to re-compute the CPR-I based on the changes occurred in the parameters associated with the serving content. For example, changes in the usage, the operational or commercial context, the transpose expense, the storage expense, the SLAs, and the like parameters for the served content can trigger for re-computation of the CPR-I, and the ranked list marks this state accordingly.

In an embodiment, at state transition 506, the system 100 can be configured to re-rank and reposition the content in the network. If the system 100 detects a change in the order of ranking then the system 100 can be configured to reorder the entire ranked list. If the system 100 detects a change in ranks due to changes in the CPR-I then the system 100 can be configured to re-rank the entire ranked list.

In an embodiment, at state transition 508, the system 100 can be configured to reposition the content in the network. In exemplary scenario, the central nodes can be configured to issue commands to reposition the content by provisioning the collaborative links in the network. In another exemplary scenario, the central nodes can be configured to issue commands to reposition the content upon detecting poor performance of collaborative links in the network. In either scenario, the content repositioning command issued (by the central nodes to the local node) can be used to appropriately transition the state of ranked list.

FIG. 6 is a flowchart illustrating a method 600 for serving content in a collaborative environment, according to the embodiments disclosed herein. The method 600 starts at 602. In an embodiment, at step 604, the method 600 includes receiving a request for particular content. In an example, the method 600 allows an end-user or any other user to provide the request for accessing the content.

In an embodiment, at step 606, the method 600 includes retrieving a list of nodes capable of participating in the collaborative environment. In an example, the method 600 can be used to improve effectiveness of the content delivery by monitoring and managing performances of the content through collaborative links. In an embodiment, at step 608, the method includes provisioning the collaboration nodes at each point of present. The overall delivery capability of the system can be enhanced by collaborating both the local and the central nodes for positioning the content in the network. In an example, the method 600 allows the nodes (both local and central) to collaborate with the collaboration nodes locally or centrally. In an embodiment, at step 610, the method 600 includes determining whether the requested content is available locally on the local nodes. In response to determining that the requested content is available on the local nodes, the method 600 includes serving the content to the user from the local storage, such as shown at step 612.

In an embodiment, at step 614, in response to determining that the requested content is not available on the local nodes, the method 600 includes determining whether the collaboration is provisioned at the local node. In an embodiment, at step 616, the method 600 includes serving the content from a content server. In an example, in response to determining that the collaboration is not provisioned at the local node, the method 600 allows the nodes 102 to serve the content from the content server. In an embodiment, at step 618, the method 600 includes identifying the collaborative nodes for establishing the collaboration. The method 600 allows central nodes to identify the collaboration nodes by scanning the collaborative nodes and searching for the particular content, such as shown at step 620. In an embodiment, at step 622, the method 600 includes recording search response feedback for the collaboration links. A feedback mechanism for performances of search and corresponding response acquired can be used to offer input to plan for improving next level of QoE.

Further, in an embodiment, at step 624, the method 600 includes determining whether the content is available at any of the collaborative node. In an example, the method 600 allows the central nodes to scan, search, and determining whether the content is available on any of the collaborative nodes. In response to determining the content is not available on any of the collaborative nodes, the method 600 includes serving the content from the content server, such as shown at step 616. In an embodiment, at 626, in response to determining that the content is available on the collaborative nodes, the method 600 includes serving the content from the collaborative nodes.

Furthermore, in an embodiment, at step 628, the method 600 includes recording serving performance of the collaboration links. In an example, the method 600 allows the local node to monitor and report the performances of each collaborative link to the central nodes for further analysis. Any change in the performance of the collaborative links can effective the performance of the over all system 100. The feedback mechanism for reporting the performances of the collaborative links can be used to offer input to plan for improving next level of QoE. In an embodiment, at step 630, the method 600 includes consolidating the performances results for the collaborative links. In an example, the method 600 allows the central nodes to consolidate the search response performance and serving performance of the collaborative links. In an embodiment, at step 632, the method 600 includes frequently reporting consolidate performances results to the central nodes. The method 600 allows the local nodes to frequently monitor the performance of the collaborative links and report to the central node for further analysis. In an embodiment, at step 634, the method 600 includes analyzing and identifying the collaborating links using the feedback received from the local nodes. In an example, the method 600 allows the central nodes to analyze the performances of the collaborative links and use the feedback to offer input to plan for improving next level of QoE. Further, the method 600 ends at step 636.

FIG. 7 is a flowchart illustrating a method 700 for network-context based content positioning, according to the embodiments disclosed herein. In an embodiment, at step 702, the method 700 includes receiving a request for particular content. In an example, the method 600 allows an end user or any other user to provide the request for accessing the content.

In an embodiment, at step 704, the method 700 includes measuring or receiving a plurality of parameters associated with the content. In an example, the parameters described herein can include for example, usage, transport cost, resources, storage space, service level agreements (SLAs), and the like associated with the content. In an embodiment, at step 706, the method 700 includes computing a CPR-I index using the parameters associated with the content. The content can be provided to users from a plurality of nodes including both local and central nodes passing through various level of content serving paths. The local ingestion point for popular content can enable offering better quality of experience (QoE) for the local users. The central intelligence for content positioning can keep track of demographic popularity to improve the overall QoE. The CPR-I can be computed (both locally and centrally) by prioritizing the one or more parameters associated with the content at each node in the network. Further, the method 700 includes combining the priorities of the plurality of parameters to compute the CPR-I, both locally and centrally.

In an embodiment, at step 708, the method 700 includes ranking the content using the computed CPR-I. In an example, the method 700 allows the local and central nodes to locally and centrally rank the content, such as to identify whether the content qualifies to cache/store in particular position of the network. The locally and centrally computed CPR-I and the corresponding content identifier along with the local raking of the content can be maintained in the metadata 200. The method 700 allows each local node to track the content over the communication and frequently update the central nodes with the CPR-I and meta-information of tracked content.

In an embodiment, at step 710, the method 700 includes positioning/repositioning the content in the network using the CPR-I. The method 700 further includes providing/delivering the content to the user, such as shown at 712. The method 700 can be used to improve effectiveness of the content delivery by monitoring and managing performances of the content through collaborative links. The overall delivery capability can be enhanced by collaborating both local and central nodes to position the content in the network.

Further, in an embodiment, at step 714, the method 700 includes frequently monitoring the parameters associated with the content. In an example, the method 700 allows the local nodes to monitor and measure parameters associated with the content and the performance of each collaborative link. In an embodiment, at step 716, the method 700 includes determining whether any changes detected based on the monitoring results. In response to determining a change, the method 700 includes re-computing the CPR-I associated with the served content, such as shown at step 718. In an example, the change in the values for the monitored parameters associated with the served content can act as a trigger for initiating computing/re-computation of the CPR-I for the particular content.

In an embodiment, at step 720, the method 700 includes re-ranking the served content based on the recomputed/updated CPR-I. If the CPR-I of particular content changes significantly then the current ranking (may be local or central) may not be valid. For example, if there a change in the order of the ranks due to the change in CPR-I and/or the performance of the collaborative links, then the method 700 allows the central/local nodes to re-rank the content using the recomputed/updated CPR-I.

In an embodiment, at step 722, the method 700 includes repositioning the content in the network based on the recomputed/updated CPR-I. In an example, the method 700 allows the central nodes to issue commands to reposition the content by provisioning the collaborative links in the network. Further, the method 700 allows the central nodes to issue commands to reposition the content upon detecting poor performance of collaborative links in the network. Furthermore, the method 700 includes repeating the steps 712 through 722.

The various actions, steps, states, blocks, or acts described with respect to the FIGS. 3 and 7 can be performed in sequential order, in random order, simultaneously, parallel, or a combination thereof. Further, in some embodiments, some of the steps, states, blocks, or acts can be omitted, skipped, modified, or added without departing from the scope of the embodiments.

FIG. 8 illustrates a computing environment 802 implementing the method and systems as disclosed in the embodiments herein. As depicted the computing environment 802 comprises at least one processing unit 804 that is equipped with a control unit 806 and an Arithmetic Logic Unit (ALU) 808, a memory 810, a storage unit 812, plurality of networking devices 814 and a plurality Input output (I/O) devices 816. The processing unit 804 is responsible for processing the instructions of the algorithm. The processing unit 804 receives commands from the control unit 806 in order to perform its processing. Further, any logical and arithmetic operations involved in the execution of the instructions are computed with the help of the ALU 808.

The overall computing environment 802 can be composed of multiple homogeneous and/or heterogeneous cores, multiple CPUs of different kinds, special media and other accelerators. The processing unit 804 is responsible for processing the instructions of the algorithm. Further, the plurality of processing units 804 may be located on a single chip or over multiple chips.

The algorithm comprising of instructions and codes required for the implementation are stored in either the memory unit 810 or the storage 812 or both. At the time of execution, the instructions may be fetched from the corresponding memory 810 and/or storage 812, and executed by the processing unit 804.

In case of any hardware implementations various networking devices 814 or external I/O devices 816 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 8 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for network-context based content positioning, the method comprising:
receiving at least one parameter associated with content;
computing a content positioning relevance index for at least one node using said at least one parameter; and
positioning said content in said network based on said content positioning relevance index.

2. The method of claim 1, wherein said method further comprises repositioning said content in said network using said content positioning relevance index.

3. The method of claim 1, wherein said at least one parameters associated with said content comprises at least one of usage, transport cost, resources, storage space, storage expense, and service level agreements (SLAs).

4. The method of claim 1, wherein said at least one node comprises at least one of local node and central node.

5. The method of claim 1, wherein said method further comprises collaborating said at least one node in said network.

6. The method of claim 1, wherein said method further comprises prioritizing said at least one parameter associated with said content.

7. The method of claim 6, wherein said at least one parameter associated with said content is prioritized locally.

8. The method of claim 6, wherein said at least one parameter associated with said content is prioritized centrally.

9. The method of claim 1, said method further comprises combining said at least one prioritized parameter to compute said content positioning relevance index comprises.

10. The method of claim 1, wherein said method further comprises storing said content positioning relevance index in a metadata.

11. The method of claim 1, wherein said method further comprises ranking said content based on said content positioning relevance index.

12. The method of claim 11, wherein said content is ranked locally.

13. The method of claim 11, wherein said content is ranked centrally.

14. The method of claim 11, wherein said method further comprises storing said ranking of said content in said metadata.

15. The method of claim 11, wherein said method further comprises caching said content in said network based on said ranking.

16. The method of claim 1, wherein said method further comprises monitoring said at least one parameter associated with said content in said network.

17. The method of claim 16, wherein said method further comprises frequently updating said metadata in accordance to said monitoring result.

18. The method of claim 16, wherein said method further comprises frequently updating said content positioning relevance index in accordance to said monitoring result.

19. The method of claim 1, wherein said method further comprises receiving a request to access said content in said network.

20. The method of claim 1, wherein said method further comprises:
determining whether said content is available locally; and
delivering said content in response to determining that said content is available locally.

21. The method of claim 20, wherein said method further comprises:
collaborating said at least one node in response to determining that said content is available centrally;
scanning said at least one node to identify said content using said content positioning relevance index; and
delivering said content from said at least one collaborated node.

22. A system for network-context based content positioning, the system comprising a processor configured to:
receive at least one parameter associated with content,
compute a content positioning relevance index for at least one node using said at least one parameter, and
position said content in said network based on said content positioning relevance index.

23. The system of claim 22, wherein said system further configured to reposition said content in said network using said content positioning relevance index.

24. The system of claim 22, wherein said at least one parameters associated with said content comprises at least one of usage, transport cost, resources, storage space, storage expense, and service level agreements (SLAs).

25. The system of claim 22, wherein said at least one node comprises at least one of local node and central node.

26. The system of claim 22, wherein said system further configured to collaborate said at least one node in said network.

27. The system of claim 22, wherein said system further configured to prioritize said at least one parameter associated with said content.

28. The system of claim 27, wherein said at least one parameter associated with said content is prioritized locally.

29. The system of claim 27, wherein said at least one parameter associated with said content is prioritized centrally.

30. The system of claim 22, wherein said system further configured to combine said at least one prioritized parameter to compute said content positioning relevance index comprises.

31. The system of claim 22, wherein said system further configured to store said content positioning relevance index in a metadata.

32. The system of claim 22, wherein said system further configured to rank said content based on said content positioning relevance index.

33. The system of claim 32, wherein said content is ranked locally.

34. The system of claim 32, wherein said content is ranked centrally.

35. The system of claim 32, wherein said system further configured to store said ranking of said content in said metadata.

36. The system of claim 32, wherein said system further configured to cache said content in said network based on said ranking.

37. The system of claim 22, wherein said system further configured to monitor said at least one parameter associated with said content in said network.

38. The system of claim 37, wherein said system further configured to frequently update said metadata in accordance to said monitoring result.

39. The system of claim 37, wherein said system further configured to frequently update said content positioning relevance index in accordance to said monitoring result.

40. The system of claim 22, wherein said system further configured to receive a request to access said content in said network.

41. The system of claim 22, wherein said system further configured to:
determine weather said content is available locally, and
deliver said content in response to determining that said content is available locally.

42. The system of claim 41, wherein said system further configured to:
collaborate said at least one node in response to determining that said content is available centrally,
scan said at least one node to identify said content using said content positioning relevance index, and
deliver said content from said at least one collaborated node.

43. A computer program product for network-context based content positioning, the product comprising:
an integrated circuit comprising at least one processor;
at least one memory having a computer program code within said circuit, wherein said at least one memory and said computer program code with said at least one processor cause said product to:
receive at least one parameter associated with content,
compute a content positioning relevance index for at least one node using said at least one parameter, and
position said content in said network based on said content positioning relevance index.
